(19) United States
(12) Patent Application Publication
(10) Pub. No.: US 2024/0290998 A1
(43) Pub. Date: Aug. 29, 2024

(54) SURFACE COATINGS FOR ANTI-CORROSIVE ANODE COMPONENTS IN HYDROGEN FUEL CELL MODULES

(71) Applicant: GM Global Technology Operations LLC, Detroit, MI (US)

(72) Inventors: Seongchan Pack, West Bloomfield Township, MI (US); Kanako Okada, Royal Oak, MI (US); Nikhil Chincholkar, Bangalore (IN)

(21) Appl. No.: 18/173,899

(22) Filed: Feb. 24, 2023

(51) Int. Cl. H01M 8/04089; H01M 8/0258

(52) U.S. Cl. CPC H01M 8/04089; H01M 8/0258; H01M 2250/20

(57) ABSTRACT

A valve for a hydrogen fuel cell module, a hydrogen fuel cell module including a valve, and a method of applying a surface coating on a valve. The valve includes a valve body defining an interior including a base material. The base material has a first surface. The valve also includes a surface coating disposed on the base material. The surface coating includes a surface layer having a second surface opposing the first surface. The surface layer contacts the first surface, and the surface layer comprises a first polymer. The surface coating also includes a dielectric layer contacting the second surface. In a hydrogen fuel cell module, the valve is connected to an exhaust flow path downstream of at least one of an anode or a cathode of a hydrogen fuel cell stack.

### INTRODUCTION

Hydrogen fuel cell technology may be used to replace or augment internal combustion engines as a power generation source in vehicles (personal and commercial), airplanes, trains, boats, generators, and appliances. Hydrogen is available and may be derived from a number of resources including natural gas, coal, solar energy, wind, and biomass. When used in electric vehicles, hydrogen fuel cells produce water vapor and warm air with no other emissions. In addition, hydrogen tanks may be replenished relatively quickly in vehicles, particularly commercial vehicles, which can have a driving range of over 300 miles. However, the environmental conditions within the exhaust downstream can become corrosive. In addition, the acid levels in the exhaust can be altered, and increased (lowering pH), by the invasion of ionic residues with impurities and increased hydrogen/saturated water diffusion into the anode components.

While current hydrogen fuel cell technology achieves its intended purpose, room remains for development of materials and components for use in hydrogen fuel cell electric vehicles.

### SUMMARY

According to various aspects, the present disclosure relates to a valve for a hydrogen fuel cell module. The valve includes a valve body defining an interior including a base material. The base material has a first surface. The valve also includes a surface coating disposed on the base material. The surface coating includes a surface layer having a second surface opposing the first surface. The surface layer contacts the first surface, and the surface layer comprises a first polymer. The surface coating also includes a dielectric layer contacting the second surface.

In embodiments, the surface layer includes at least one of a crosslinked polymer and a first semicrystalline polymer, wherein the first semicrystalline polymer exhibits a degree of crystallinity in the range of 50 percent to 80 percent.

In any of the above embodiments, the surface layer exhibits a thickness in the range of 2 micrometers to 10 micrometers.

In any of the above embodiments, the crosslinked polymer includes at least one of epoxy and polyurethane. Alternatively, in embodiments of the above, the first semicrystalline polymer includes at least one of high-density polyethylene, isotactic polypropylene, syndiotactic polystyrene, polytetrafluorethylene, polyoxymethylene, and liquid crystal polymer.

In any of the above embodiments, the surface layer includes fiber.

In any of the above embodiments, the dielectric layer exhibits a thickness in the range of 0.01 millimeters to 2 millimeters.

In any of the above embodiments, the dielectric layer exhibits a dielectric strength in the range of 1 kV per millimeter to 200 kV per millimeter.

In any of the above embodiments, the dielectric layer includes a second semicrystalline polymer, wherein the second semicrystalline polymer exhibits a degree of crystallinity in the range of 10 percent to 80 percent. In further embodiments, the second semicrystalline polymer includes at least one or more of the following: polyimide, polyether ether ketone, polyphthalamide, and polyphenylene sulfide.

Alternatively, to the semicrystalline polymer, in any of the above embodiments, the dielectric layer includes at least one of: thermoplastic elastomers, thermoplastic olefins, and polycarbonate.

In any of the above embodiments, the dielectric layer includes a ceramic and the ceramic includes at least one or more of the following ceramics: glass ceramic, aluminum oxide (Al₂O₃), zirconia (ZrO₂), chromium oxide (Cr₂O₃), titania (TiO₂), and yttria stabilized zirconia (ZrO₂—Y₂O₃), aluminum-silicon oxide, oxidized graphite, graphene, and aluminum-silicon-polyester.

According to various additional aspects, the present disclosure is directed to a hydrogen fuel cell module. The hydrogen fuel cell module includes a fuel cell stack including an anode and a cathode and an exhaust flow path connected to at least one of the anode and cathode. The hydrogen fuel cell module also includes a valve, connected to the exhaust flow path downstream of the one of the anode and cathode. The valve includes a valve body defining an interior. The interior includes a base material having a first surface and a surface coating disposed on the base material. The surface coating includes a surface layer having a second surface opposing the first surface, wherein the surface layer contacts the first surface, and the surface layer comprises a first polymer. The surface coating also includes a dielectric layer, wherein the dielectric layer contacts the second surface. In addition, the hydrogen fuel cell module includes a water separator connected to the exhaust flow path downstream of the valve.

According to embodiment of the above, the surface layer includes at least one of a cross-linked polymer and a first semicrystalline polymer, which exhibits a degree of crystallinity in the range of 50 percent to 80 percent. In addition, the surface layer exhibits a thickness in the range of 2 micrometers to 10 micrometers.

According to any of the above embodiments, the dielectric layer includes at least one of a second semicrystalline polymer and a ceramic. The second semicrystalline polymer exhibits a degree of crystallinity in the range of 10 percent to 80 percent. The dielectric layer exhibits a thickness in the range of 0.01 millimeters to 2 millimeters.

According to various yet additional aspects, the present disclosure relates to a method of applying a surface coating onto a valve. The method includes applying a surface layer on a first surface of a base material of an interior of a valve body. The surface layer comprises a first polymer and includes a second surface opposing the first surface. A dielectric layer is applied and contacts the second surface of the surface layer.

In any of the above embodiments, the dielectric layer comprises a second polymer and applying the dielectric layer includes over molding the second polymer on the first polymer.

In any of the above embodiments, the first polymer includes a crosslinked polymer and applying the surface layer comprises applying a pre-polymer on the base material and crosslinking the pre-polymer. In further embodiments, the pre-polymer is applied by one or more of the following processes: dip coating, spraying, plating, casting, and additive manufacturing process. In alternative embodiments, the first polymer comprises a semicrystalline polymer and applying the surface layer comprises over molding the first polymer on the base material.

### BRIEF DESCRIPTION OF DRAWINGS

The drawings described herein are for illustration purposes only and are not intended to limit the scope of the present disclosure in any way.

FIG. 1 illustrates a vehicle including an embodiment of a hydrogen fuel cell module forming a part of a larger hydrogen fuel cell stack for use in a vehicle, according to embodiments of the present disclosure;

FIG. 2 illustrates the anode side of the fuel cell, according to embodiments of the present disclosure;

FIG. 3 illustrates a surface coating, according to embodiments of the present disclosure; and

FIG. 4 illustrates a flow chart of a method of applying the surface coating, according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

As used herein, the term “vehicle” is not limited to automobiles. While the present technology is described primarily herein in connection with electric vehicles, the technology is not limited to electric vehicles. The concepts can be used in a wide variety of applications, such as in connection with motorcycles, mopeds, locomotives, aircraft, marine craft, and other vehicles, as well as in other applications incorporating hydrogen fuel cells, such as in applications incorporating electric motors. Applications include, for example, industrial machines and motors, agricultural equipment, compressors, defense equipment, HVAC systems, residential and commercial power generators, and pumps.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is directed to a surface coating utilizing a dielectric material and a densified surface layer for the neutralization of potentially corrosive surfaces in the anode side, cathode side, or both anode and cathode sides of a fuel cell stack, such as a valve including check valves or bypass valves The dielectric layer provides an electrical shunt path for ionic contamination and the densified surface layer reduces the penetration of ionized molecules through the coatings. The fuel cell component base material may be formed from metal, including steel or aluminum, ceramic, polymer, or composite.

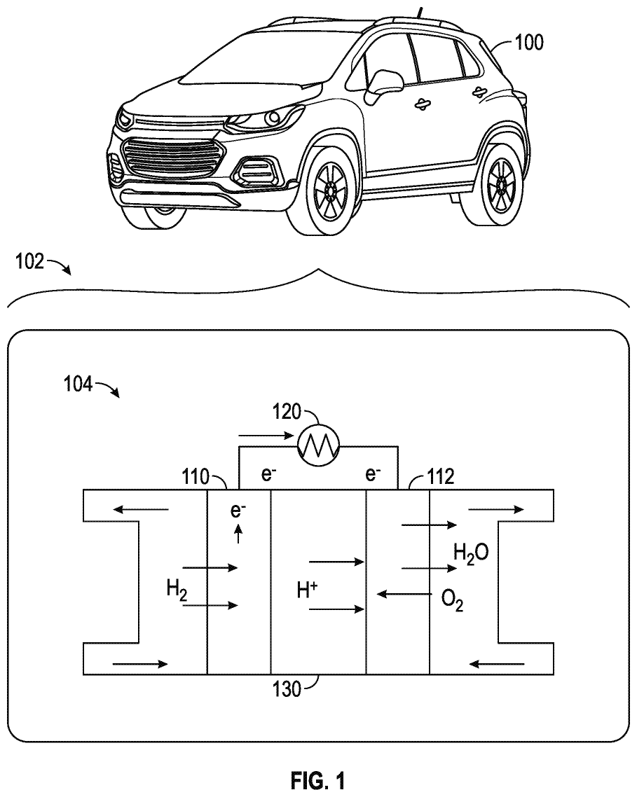

Reference is now made to FIG. 1 illustrating a hydrogen fuel cell electric vehicle 100 including a hydrogen fuel cell module 102. While a hydrogen fuel cell module 102 includes multiple hydrogen fuel cells, often referred to as a fuel cell stack, one fuel cell 104 is illustrated for purposes of description herein. Fuel cells 104 generate electricity from hydrogen through a reaction of hydrogen and oxygen to produce water. Within the fuel cell 100, two electrodes (an anode 110 and cathode 112), connected by an electrical circuit 120, are disposed on either side of a polymer electrolyte membrane 130. Hydrogen H₂ is oxidized at the anode 110 and positive hydrogen ions H⁺ (protons) and electrons e⁻ are created. The protons H⁺ flow through the membrane 130 toward the cathode 112, where oxygen O₂ is reduced via the electrons e⁻ generated from the hydrogen H⁺ protons and provided by the electrical circuit 120. The reduced oxygen ions O⁻ then react with the hydrogen H⁺ protons to form water H₂O. The flow of the electrons e⁻ from the anode to the cathode provides power to the vehicle.

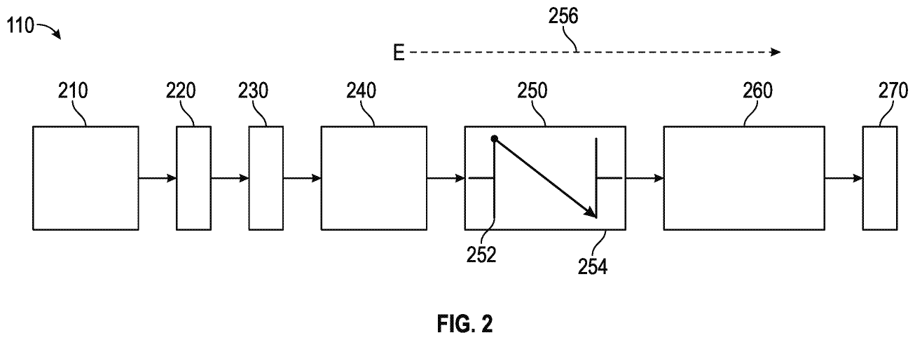

FIG. 2 illustrates, for example, the anode side 110 of the fuel cell module 102. Hydrogen is supplied by one or more hydrogen tanks 210 into an injector 220. The injector 220 injects hydrogen H₂, optionally though a metering system 230 that may combine recirculated hydrogen, into the anode side of the fuel cell stack 240. Exhaust E, including hydrogen H₂, saturated water, and nitrogen, passes out of the fuel cell stack 240 through an exhaust flow path 256, which is connected to the anode side 110 of the fuel cell stack 240. Connected to the exhaust flow path 256 is a valve 250, which at least partially defines the exhaust flow path 256. While a check valve is illustrated, the valve 250 includes a check valve or a bypass valve. Check valves are understood to provide one way flow through the valve. Check valves may include pressure valves, such as ball check valves, piston check valves, reed valves, butterfly valves, duckbill valves, etc. Bypass valves also allow flow through the valve once a particular pressure is reached on one or both sides of the valve. Once the exhaust E builds up to a sufficient pressure, i.e., the actuation pressure of the valve 250, the valve 250 actuates releasing the exhaust E. The valve body may be integrated into a case, such as the case enclosing the fuel cell module 102, or the valve body may be stand alone. Water is removed from the exhaust E through a water separator 260 connected to the exhaust flow path 256 downstream of the valve 250, which optionally includes an anode heat exchanger 270 for heating non-recycled hydrogen. The hydrogen and saturated water of the exhaust E is relatively acidic, having a pH of less than 6, including all values and increments therein, such as in the range of 0 to 5. In embodiments, sensors may be provided before and after the valve 250 in the exhaust flow path 256. The sensors may measure one or more of the following characteristics of the exhaust: pressure and water acidity.

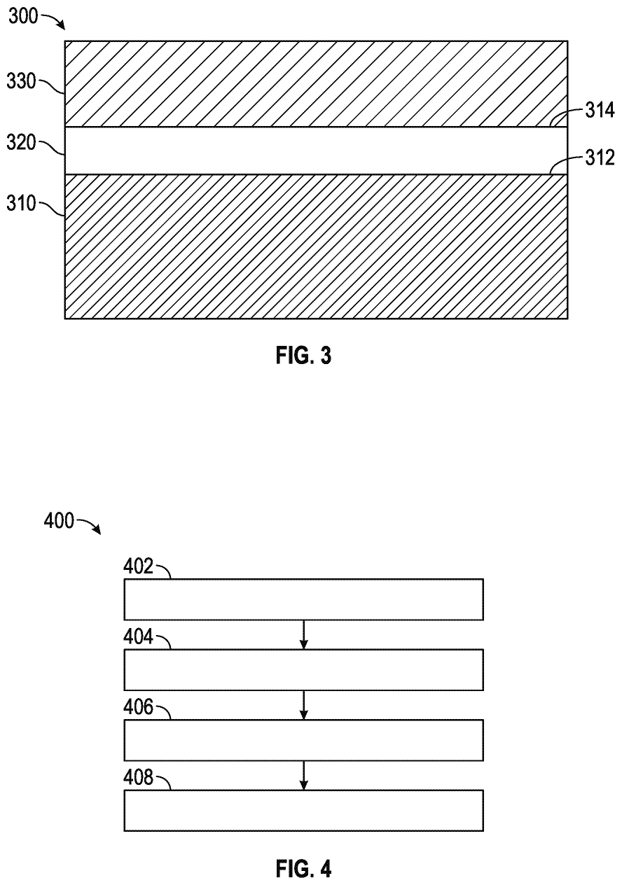

FIG. 3 illustrates a portion of the interior 252 of the valve 250 defined by the valve body 254 (see FIG. 2) include a surface coating 300 disposed on a base material 310 of the valve body. In embodiments, the base material 310 includes a metal such as steel or aluminum, ceramic, polymer, or a composite thereof. In embodiments, the surface coating 300 directly contacts the base material 310.

The surface coating 300 includes a surface layer 320, which is the coating layer that is the closest layer, and adjacent to, to the base material 310. The surface layer 320 reduces hydrogen H₂ and saturated H₂O permeability of the surface coating 300. The surface layer 320 includes a first polymer. The first polymer includes at least one of a cross-linked polymer and a semicrystalline polymer of a few micrometers in thickness, such as in the range of 2 micrometers to 10 micrometers. The crosslinked polymer includes, for example, at least one of epoxy and crosslinked polyurethane. The semicrystalline polymer used in the surface layer 320 exhibits a relatively high degree of crystallinity in the range of 50 percent to 80 percent, including all values and ranges therein, as measured by differential scanning calorimetry, using ASTM protocol E794-06 (2018). In embodiments, crystallinity may also be used by x-ray diffraction techniques. The semicrystalline polymer includes, in embodiments, at least one of the following polymers: high density polyethylene, isotactic polypropylene, syndiotactic polystyrene, polytetrafluoroethylene, polyoxymethylene, and liquid crystal polymers.

Alternatively, or additionally, the surface layer 320 may include fiber or oxide particles. In embodiments, the surface layer 320 includes 30 percent by weight to 100 percent by weight fiber of the total weight of the surface layer 320, including all values and ranges therein such as from 30 percent by weight to 90 percent by weight fiber. In embodiments including less than 100 percent by weight of fiber, the fiber is embedded in a polymer matrix of a first polymer, including any of the above polymer materials, i.e., the cross-lined polymer or crystalline polymer. In embodiments, the fiber includes one or more of glass, carbon, carbon nanotube, graphene, or thermoplastic fibers, such as Kevlar fiber or Nomex fiber. In embodiments, the fibers may be milled, and exhibit an average fiber length of less than 1 millimeter, short fibers exhibiting an average fiber length in the range of 1 millimeter to 3 millimeters, chopped fiber exhibiting average fiber length in the range of 3 millimeters to 6 millimeters, long fibers exhibiting average fiber length of greater than 6 millimeter including filaments. In further embodiments, the fiber is provided as a non-woven or woven mat, which is adhered to the base material 310. In yet further embodiments, the fiber is a nanofiber, exhibiting a length of less than 1 micrometer, and produced by electrospinning. In alternative, or additional embodiments, the surface layer 320 includes 30 percent by weight to 98 percent by weight oxides of the total weight of the surface layer 320, including all values and ranges therein such as from 30 percent by weight to 75 percent by weight oxides, and the remainder of the surface layer 320 includes the first polymer.

The surface layer 320 may be applied by one or more polymer processing techniques including coating, molding, or additive manufacturing methods. For example, coating techniques may include dip coating, spraying, or casting; molding techniques include over-molding; and additive manufacturing methods may include 3D printing used fused filament fabrication or powdered bed fusion.

The surface coating 300 also includes a dielectric layer 330 of a second, polymer or a ceramic coating disposed on the surface layer 320. The dielectric layer provides an electrical shunt path for ionic contaminants. The dielectric layer 330, in embodiments, includes at least one of a second polymer and a ceramic that exhibits a dielectric constant in the range of 2.0 to 12, including all values and ranges therein, measured at room temperature (in the range of 21 degrees Celsius to 23 degrees Celsius) under 1 kHz. The second polymer or ceramic of the dielectric layer 330 may also, or alternatively, exhibit a dielectric strength in the range of 1 kV per millimeter to 200 kV per millimeter, including all values and ranges therein, such as 16 to 45, 11 to 31, and 22 to 31. In embodiments, the second polymer is a semicrystalline polymer, which is understood as exhibiting a degree of crystallinity in the range of 10 to 80 percent, including all values and ranges therein. The second semicrystalline polymer includes, for example, one or more of polyimide, polyether ether ketone, polyphthalamide, and polyphenylene sulfide. In additional embodiments, the second polymer is a relatively flexible polymer, such as thermoplastic elastomers, thermoplastic olefins, or polycarbonate. The ceramic includes, for example, one or more of the following ceramics: glass ceramic, aluminum oxide (Al₂O₃), zirconia (ZrO₂), chromium oxide (Cr₂O₃), titania (TiO₂), and yttria stabilized zirconia (ZrO₂—Y₂O₃), aluminum silicon-oxide, aluminum silicon polyester, oxidized graphite, and graphene. The dielectric layer 330 may be up to a few millimeters in thickness, such as in the range of 0.01 millimeters to 2 millimeters, including all values and ranges therein. Alternatively, or additionally, the dielectric layer 330 includes dielectric metal particles embedded in a matrix of the dielectric semi-crystalline polymer. In aspects, the dielectric behavior of the dielectric layer may be directional. The dielectric layer may be applied by one of a number of polymer processing techniques including, for example, a molding process or a coating process.

In embodiments, more than one layer of the surface coating 300 may be applied each layer with its own surface layer 320 and dielectric layer 330, wherein the coatings are stacked, and at least one of the layers are formed from the different materials to provide performance in a wide range of pH levels and operating temperatures. Additional coating materials may also be provided to perform additional functions. Further, other components defining the exhaust flow path 256 of the anode side 110 of the fuel cell module 102, may include the surface coating 300.

Reference is now made to FIG. 4, with further reference to FIGS. 1 through 3, illustrating a method 400 for applying the surface coating 300 onto the base material 310 of the valve 250, or other component in the exhaust flow path 256 of the anode side 110 of the hydrogen fuel cell 102. Optionally, at block 402, the first surface 312 of the base material 310 may be prepared using one of a number of methods to clean the base material 310, removing dirt and other impurities that may be present from the surface 312. Methods for cleaning the base material 310 include, for example, laser etching, chemical etching, sandblasting, chemical cleaning, flame blasting, corona discharge, flame treatment, and plasma treatment.

At block 404, the surface layer 320 is applied to the first surface 312 of the base materials 310. In the case where the surface layer 320 is a crosslinked polymer, a pre-polymer may be applied by one or more of the following processes including dip coating, spraying, plating, casting, and additive manufacturing the pre-polymer on to the surface 312. The pre-polymer may then cross-link to form the cross-linked polymer in place, forming a coating on the surface 312. In embodiments where the crosslinked polymer is a multi-component polymer, the components may be combined prior to applying the pre-polymer to the surface. In embodiments where the crosslinked polymer is a single component polymer, the pre-polymer may be directly applied and allowed to crosslink in place. In embodiments, where the polymer is a thermoplastic polymer, the polymer may be solvent sprayed or solvent cast on the surface 312, or over molded onto the surface 312. In the case where the surface layer 320 include fibers, the fibers may be applied to the surface in a matrix of the crosslinked polymers or the thermoplastic polymer or the fibers may be applied as fabric mat and adhered to the base material 310.

At block 406 the dielectric layer 330 is applied onto the exposed, second surface 314 of the surface layer 320 opposing the first surface 312. The dielectric layer 330 may be applied by an over molding process or a coating process, such as thermal spray coating and plating, or additive manufacturing process. At block 408, the valve 250 or other components in the exhaust flow path 256 are assembled with the remaining components of the anode side 110 of the hydrogen fuel cell 102.

If additional layers are present, the method above may be repeated until the desired number of layers have been formed on the base material 310.

The surface coating of the present disclosure offers several advantages. One advantage is the prevention of corrosion due to exposure to acidic conditions, such as acidic water exhibiting a pH of less than 6. Prevention of corrosion reduces the possibility of mechanical failure. Prevention of corrosion also reduces the possibility of electrical failure when the valve and other components are formed from a metal, or another material, that is electrically conductive and may short the fuel cell. Another advantage is the prevention of hydrogen embrittlement of metal components.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A valve for a hydrogen fuel cell module, comprising:
a valve body defining an interior including a base material, wherein the base material has a first surface; and
a surface coating disposed on the base material, the surface coating including:
a surface layer having a second surface opposing the first surface, wherein the surface layer contacts the first surface and the surface layer comprises a first polymer, and
a dielectric layer, wherein the dielectric layer contacts the second surface.

2. The valve of claim 1, wherein the surface layer includes at least one of a crosslinked polymer and a first semicrystalline polymer, wherein the first semicrystalline polymer exhibits a degree of crystallinity in the range of 50 percent to 80 percent.

3. The valve of claim 2, wherein the surface layer exhibits a thickness in the range of 2 micrometers to 10 micrometers.

4. The valve of claim 3, wherein the crosslinked polymer includes at least one of epoxy and polyurethane.

5. The valve of claim 3, wherein the first semicrystalline polymer includes at least one of high-density isotactic polypropylene, syndiotactic polystyrene, polytetrafluorethylene, polyoxymethylene, and liquid crystal polymer.

6. The valve of claim 3, wherein the surface layer includes fiber.

7. The valve of claim 1, wherein the dielectric layer exhibits a thickness in the range of 0.01 millimeters to 2 millimeters.

8. The valve of claim 7, wherein the dielectric layer exhibits a dielectric strength in the range of 1 kV per millimeter to 200 kV per millimeter.

9. The valve of claim 8, wherein the dielectric layer includes a second semicrystalline polymer, wherein the second semicrystalline polymer exhibits a degree of crystallinity in the range of 10 percent to 80 percent.

10. The valve of claim 9, wherein the second semicrystalline polymer includes at least one or more of the following: polyimide, polyether ether ketone, polyphthalamide, and polyphenylene sulfide.

11. The valve of claim 8, wherein the dielectric layer includes at least one of: thermoplastic elastomers, thermoplastic olefins, and polycarbonate.

12. The valve of claim 8, wherein the dielectric layer includes a ceramic and the ceramic includes at least one or more of the following ceramics: glass ceramic, aluminum oxide (Al₂O₃), zirconia (ZrO₂), chromium oxide (Cr₂O₃), titania (TiO₂), and yttria stabilized zirconia (ZrO₂—Y₂O₃), aluminum-silicon oxide, oxidized graphite, graphene, and aluminum-silicon-polyester.

13. A hydrogen fuel cell module, comprising:
a fuel cell stack including an anode and a cathode;
an exhaust flow path connected to at least one of the anode and the cathode;
a valve, wherein the valve is connected to the exhaust flow path downstream of the one of the anode and the cathode, the valve including a valve body defining an interior, wherein the interior includes a base material having a first surface, a surface coating disposed on the base material, the surface coating including: a surface layer having a second surface opposing the first surface, wherein the surface layer contacts the first surface and the surface layer comprises a first polymer, and a dielectric layer, wherein the dielectric layer contacts the second surface; and
a water separator connected to the exhaust flow path downstream of the valve.

14. The hydrogen fuel cell module of claim 13, wherein the surface layer includes at least one of a cross-linked polymer and a first semicrystalline polymer, wherein the first semicrystalline polymer exhibits a degree of crystallinity in the range of 50 percent to 80 percent, and wherein the surface layer exhibits a thickness in the range of 2 micrometers to 10 micrometers.

15. The hydrogen fuel cell module of claim 14, wherein the dielectric layer includes at least one of a second semicrystalline polymer, wherein the second semicrystalline polymer exhibits a degree of crystallinity in the range of 10 percent to 80 percent, and a ceramic, and the dielectric layer exhibits a thickness in the range of 0.01 millimeters to 2 millimeters.

16. A method of applying a surface coating onto a valve, comprising:
applying a surface layer on a first surface of a base material of an interior of a valve body, and the surface layer comprises a first polymer and includes a second surface opposing the first surface; and
applying a dielectric layer, wherein the dielectric layer contacts the second surface.

17. The method of claim 16, wherein the dielectric layer comprises a second polymer and applying the dielectric layer includes over molding the second polymer on the first polymer.

18. The method of claim 17, wherein the first polymer includes a crosslinked polymer and applying the surface layer comprises applying a pre-polymer on the base material and crosslinking the pre-polymer.

19. The method of claim 18, wherein the pre-polymer is applied by one or more of the following processes: dip coating, spraying, plating, casting, and additive manufacturing process.

20. The method of claim 17, wherein the first polymer comprises a semicrystalline polymer and applying the surface layer comprises over molding the first polymer on the base material.
